(19) United States
(12) Patent Application Publication
(10) Pub. No.: US 2002/0107886 A1
(43) Pub. Date: Aug. 8, 2002

(54) Method and apparatus for automatic document electronic versioning system

(76) Inventors: Donald R. Gentner, Palo Alto, CA (US); John C. Tang, Palo Alto, CA (US); Nicole Y. Mordecai, Weston, MA (US); James M.A. Begole, Mountain View, CA (US); Michael L. Van De Vanter, Mountain View, CA (US)

Correspondence Address: COUDERT BROTHERS LLP, 333 SOUTH HOPE STREET, 23RD FLOOR, LOS ANGELES, CA, 90071, US

(21) Appl. No.: 09/778,553

(22) Filed: Feb. 7, 2001

(51) Int. Cl. G06F 17/24; G06F 17/21

(52) U.S. Cl. 707/511; 707/530

(57) ABSTRACT

The present invention provides a method and apparatus for automatic electronic document versioning system. One embodiment of the present invention automatically and permanently saves information about the changes made between successive document states. Thus, every previous document state is retrievable. Another embodiment provides an interface for retrieving previous document states. A set of potentially memorable events are arranged in a timeline and used to identify certain previous document states. In one embodiment, closing a document is a memorable event used to identify a document state. In another embodiment, copying or synchronizing the document to another device is a memorable event used to identify a document state. In yet another embodiment, attaching the document to an electronic mail message is a memorable event used to identify a document state. In yet another embodiment, a user explicitly requesting a document state be saved as memorable is a memorable event used to identify a document state. In yet another embodiment, the document remaining unchanged for a significant period of time is a memorable event used to identify a document state. In one embodiment of the present invention, a previous document state is retrieved through committing a series of undos. In another embodiment, a previous document state is retrieved by selecting a document state associated with a memorable event on a timeline. In yet another embodiment, a previous state is retrieved by a combination of committing a series of undos and selecting a document state associated with a memorable event on a timeline.

### BACKGROUND OF THE INVENTION

1. Field of the Invention

The present invention relates to the field of computer software, and in particular to a method and apparatus for automatic electronic document versioning.

Sun, Sun Microsystems, the Sun logo, Solaris and all Java-based trademarks and logos are trademarks or registered trademarks of Sun Microsystems, Inc. in the United States and other countries. All SPARC trademarks are used under license and are trademarks of SPARC International, Inc. in the United States and other countries. Products bearing SPARC trademarks are based upon an architecture developed by Sun Microsystems, Inc.

2. Background Art

Creating and editing an electronic document takes place over a period of time. A document undergoes many changes before it reaches its current state. It is sometimes advantageous to retrieve a previous state of an electronic document. Current methods allow retrieval of only a limited number of recent electronic document states or require a user to explicitly save an electronic document state as a version for future retrieval. Frequently, needed electronic document states are not recent and not saved as a version. Thus, needed electronic document states are often not retrievable. This problem can be better understood with a review of electronic documents.

Electronic Documents

Electronic documents are collections of data and include text, graphics, sound and computer code. The collections of data are uniquely identified and stored electronically in computer storage devices. The process of creating an electronic document typically starts with an empty collection of data, termed a “blank document.” The blank document is changed through a series of small changes. For example, a word processing document begins as a blank document and is changed by adding and removing individual characters.

FIG. 1 illustrates the process of electronic document creation and modification. At step 100, a blank document is created. At step 110, it is determined whether the electronic document is to be saved. If the electronic document is to be saved, at step 120, the electronic document is saved and the process continues to step 130. If the electronic document is not to be saved, the process continues to step 130. At step 130, the electronic document is modified and the process repeats at step 110.

Saving Documents

As a user modifies an electronic document, it is saved from time to time to preserve a document state. If a catastrophic event (e.g., a power failure) causes the present state of the document to be lost, the most recent preserved state of the electronic document is retrievable. However, all modifications to the document after the state was saved and before the catastrophic event are lost.

If a document state is saved without changing the unique identifier, any document state previously saved for that unique identifier is replaced with the new document state. Thus, if a document is always saved using the same unique identifier, only the most recently saved document state can be retrieved.

For example, a word processing document identified as, or named, “letter” is opened and is in state 1. The document is modified such that the document is in state 2. If the document is saved as “letter”, state 2 replaces state 1 as the saved document state. Thus, state 1 of the word processing document becomes irretrievable.

Retrieving Previous Document States

It is frequently desirable to retrieve a previous state of an electronic document. For example, one or more of the changes between a previous document state and the current document state introduced errors in the document. Another example is a previous document state contains desired data which is not in the current document state. Prior art methods for retrieving previous document states include committing a series of undos and versioning.

Undos

One method of retrieving previous document states is to keep track of the changes between successive document states. Thus, previous document states are retrieved by undoing the changes between successive document states, beginning with the current document state. However, the change information is limited to some maximum number of state transitions. Thus, desired previous states are frequently insufficiently recent for retrieval by this method. For example, if only the changes involved in the three most recent document state transitions are recorded, previous states which require undoing four or more document state transitions are not retrievable using this method.

FIG. 2 illustrates the process of document state retrieval using a series of undos. At step 200, it is determined whether the change information is stored for the transition between the present document state and the immediately previous document state. If the change information is not stored, at step 210, the desired previous document state is not retrievable using this method. If the change information is stored, at step 220, the change is undone. At step 230, it is determined whether the new present document state is the desired document state. If the new present document state is the desired document state, at step 240 the desired document state is retrieved. If the new present document state is not the desired document state, the process repeats at step 200.

An additional limitation of using a series of undos is the change information is not stored permanently. Thus, if an event removes the change information from a computer's memory (e.g., the editing program is closed or the computer is turned off), the change information is lost. Thus, once an event removes the change information from a computer's memory, this method is unable to retrieve any previous document states.

Versioning

Another method for retrieving previous document states is to periodically save the current document state as a version of the electronic document. A version of an electronic document is a document state which is saved using a new unique identifier (e.g., a file name). Thus, once a document is saved as a new version, revisions to the document do not affect previous versions of the document.

FIG. 3 illustrates the process of creating and saving versions of an electronic document. At step 300, a blank document is created. At step 310, it is determined whether the electronic document is to be saved. If the electronic document is to be saved, at step 320, it is determined whether the electronic document is to be saved as a new version. If the electronic document is to be saved as a new version, at step 330, a new unique identifier is created for the document. At step 340, the document is saved using the new unique identifier and the process repeats at step 310.

If at step 320 the electronic document is not to be saved as a new version, at step 350, the electronic document is saved using the document's unique identifier and the process repeats at step 310. If at step 310 the electronic document is not to be saved, the process continues to step 360. At step 360, the electronic document is modified and the process repeats at step 310.

Version Retrieval

If previous document states are saved as versions, they are retrievable. For example, a word processing document identified as, or named, “letter” is opened and is in state 1. The document is modified such that the document is in state 2, and the document is saved as “letter version 2”. Thus, state 1 of the word processing document is retrievable by opening the document named “letter”. Likewise, state 2 of the word processing document is retrievable by opening the document named “letter version 2”.

FIG. 4 illustrates the process of retrieving a previous state in accordance with the versioning method. At step 400 it is determined whether the desired document state is saved as a version of the electronic document. If the desired document state is saved as a version of the electronic document, at step 410, the unique identifier for the appropriate version is used to retrieve the desired previous document state. If the desired document state is not saved as a version of the electronic document, at step 420, the desired document state is not retrievable using this method.

Display Retrieval

Another method of retrieving a previous document state is to retrieve the display output at one or more times when the electronic document was in the desired state and the electronic document was displayed. Systems exist which capture the display information for a computer system and allow a user to redisplay previous displays. Thus, a user retrieves previous document states by displaying a document as it was on the display at some previous time.

However, only the display buffer is retrieved. The display buffer is the data that instructs a display device how to display the information. For example, one embodiment of a display buffer is the data which determines pixel color on a monitor. Typically, manual and automatic reconstruction of the document state from the display buffer is costly or impossible. Additionally, many documents are large and cannot be displayed entirely at one time.

Retrievable display buffers are limited to a number of the most recent display buffers. Thus, displays which are not sufficiently recent are not retrievable. Additionally, the display buffers are not permanently stored. Thus, if an event removes a display buffer from memory, the display buffer is not retrievable. However, if a user retrieves one or more screen buffers which displays some or all of the desired document state, the document state is retrievable.

FIG. 5 illustrates the process of retrieving a document state by combining one or more previous display outputs. The document state is reconstructed by retrieving portions of the document state from previous output displays and piecing those portions together to form a complete reconstructed document state. At step 500, it is determined whether the document state is completely reconstructed. A display output may only display a portion of a document state. Thus, it may be necessary to extract portions of a document state from different display outputs and combine these portions into the complete document state. If the document state is completely reconstructed, at step 510, the electronic document is retrieved. If the document state is not completely reconstructed, at step 520, it is determined whether there exists a retrievable display output wherein some missing portion of the desired document state was displayed.

If there exists a retrievable display output wherein some missing portion of the desired document state was displayed, at step 530, that display output is retrieved. At step 540, the missing portion of the desired document state is extracted from the display data. At step 550, the extracted portion of the desired document state is combined with the desired document state recreation and the process repeats at step 500. If at step 520 there does not exist a retrievable display output wherein some missing portion of the document state was displayed, at step 560, the desired document state is not retrievable using this method.

### SUMMARY OF THE INVENTION

The present invention provides a method and apparatus for automatic electronic document versioning system. One embodiment of the present invention automatically and permanently saves information about the changes made between successive document states. Thus, every previous document state is retrievable.

Another embodiment of the present invention provides an interface for retrieving previous document states. A set of potentially memorable events are arranged in a timeline and used to identify certain previous document states. In one embodiment, closing a document is a memorable event used to identify a document state. In another embodiment, copying or synchronizing the document to another device is a memorable event used to identify a document state. In yet another embodiment, attaching the document to an electronic mail message is a memorable event used to identify a document state. In yet another embodiment, a user explicitly requesting a document state be saved as memorable is a memorable event used to identify a document state. In yet another embodiment, the document remaining unchanged for a significant period of time is a memorable event used to identify a document state.

In one embodiment of the present invention, a previous document state is retrieved through committing a series of undos. In another embodiment, a previous document state is retrieved by selecting a document state associated with a memorable event on a timeline. In yet another embodiment, a previous state is retrieved by a combination of committing a series of undos and selecting a document state associated with a memorable event on a timeline

### BRIEF DESCRIPTION OF THE DRAWINGS

These and other features, aspects and advantages of the present invention will become better understood with regard to the following description, appended claims and accompanying drawings where:

FIG. 1 is a flow diagram of the process used to create and edit a document.

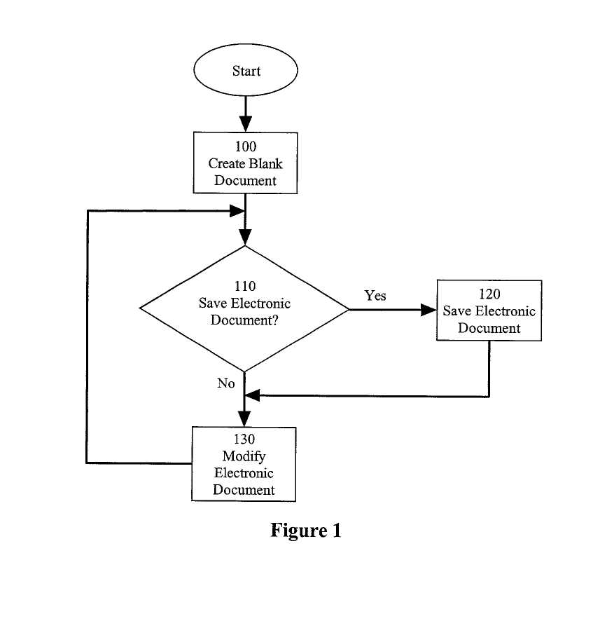

FIG. 2 is a flow diagram of the process of document state retrieval using a series of undos.

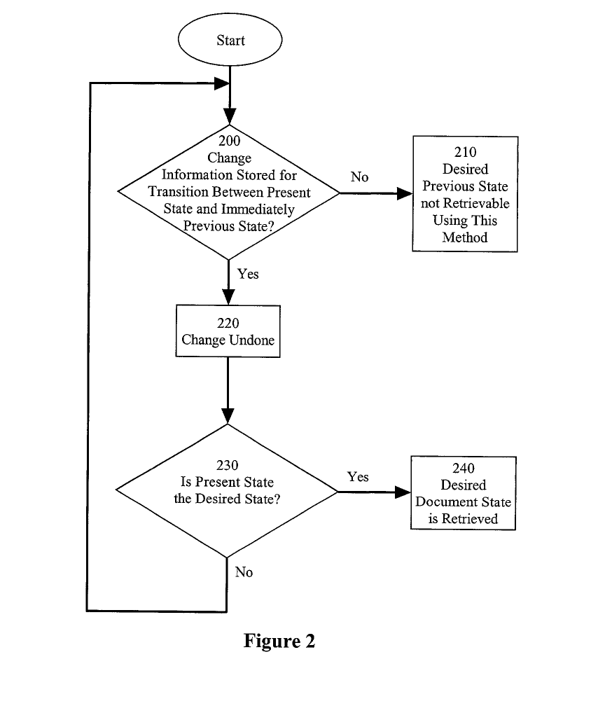

FIG. 3 is a flow diagram of the process of creating and saving versions of an electronic document.

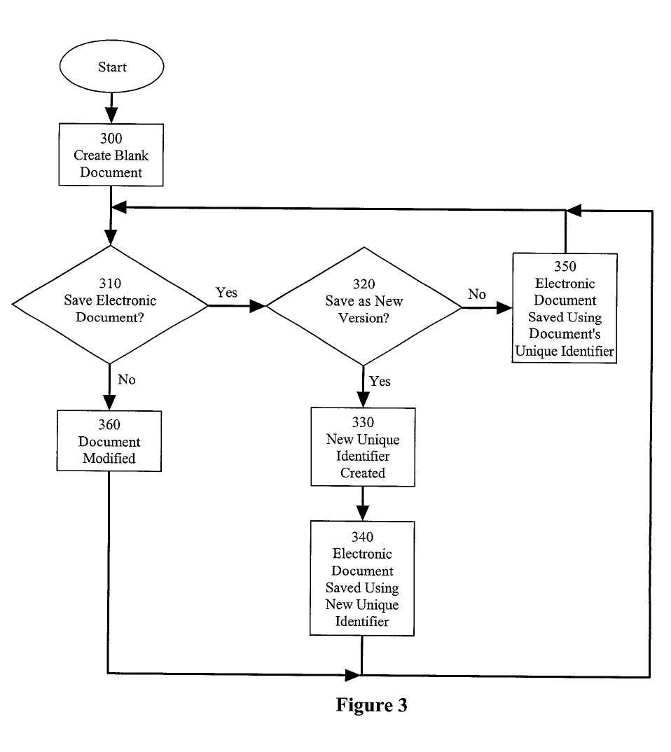

FIG. 4 is a flow diagram of the process of retrieving a previous state saved as a version.

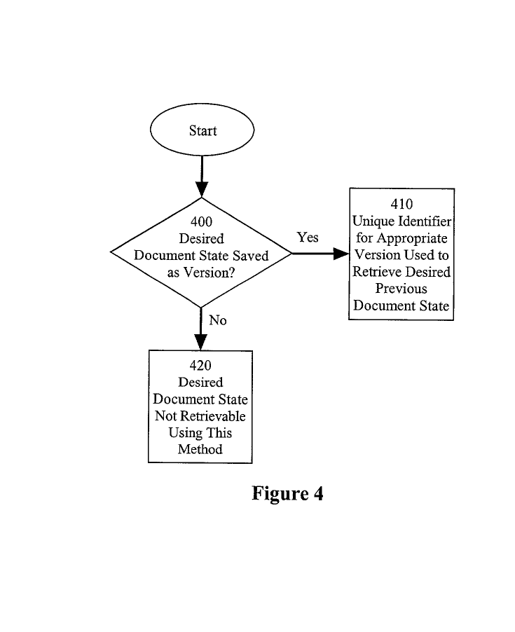

FIG. 5 is a flow diagram of the process of retrieving a document state by retrieving one or more previous display outputs.

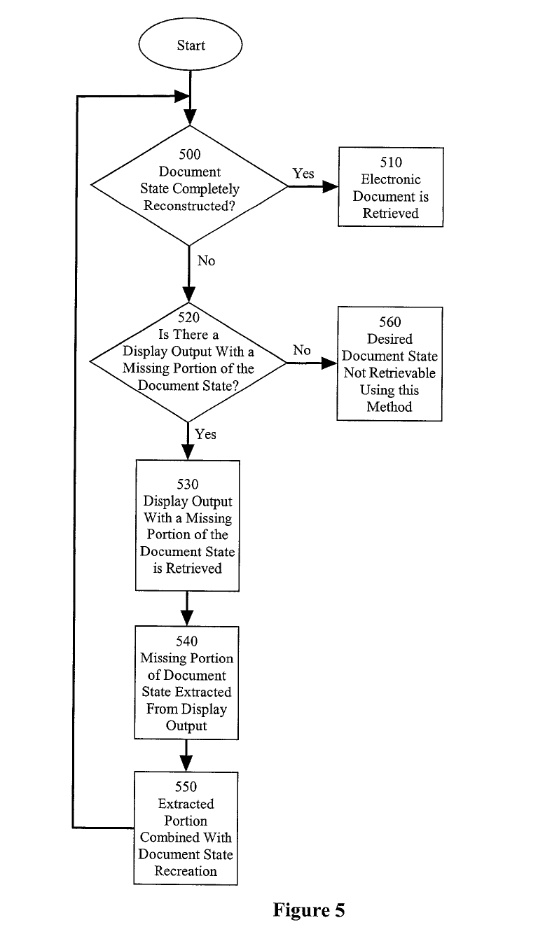

FIG. 6 is a flow diagram of the process of document creation and modification in accordance with one embodiment of the present invention.

FIG. 7 is a flow diagram of the process of document state retrieval using a series of undos beginning at the current document state in accordance with one embodiment of the present invention.

FIG. 8 is a flow diagram of the process of document state retrieval using a series of redos beginning with a blank document in accordance with one embodiment of the present invention.

FIG. 9 is a flow diagram of the process of document state retrieval using either a series of undos or redos beginning at any document state in accordance with one embodiment of the present invention.

FIG. 10 is a block diagram of an interface for previous document state retrieval in accordance with one embodiment of the previous invention.

FIG. 11 is a flow diagram of the process of selecting a previous document state for retrieval in accordance with one embodiment of the present invention.

FIG. 12 is a flow diagram of the process of document creation and modification in accordance with one embodiment of the present invention.

FIG. 13 is a block diagram of the creation of a document in accordance with one embodiment of the present invention.

FIG. 14 is a block diagram of the creation of a document in accordance with one embodiment of the present invention.

FIG. 15 is a block diagram of a general purpose computer.

### DETAILED DESCRIPTION OF THE INVENTION

The invention is a method and apparatus for automatic electronic document versioning system. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Electronic Document Creation and Modification

One embodiment of the present invention permanently saves information about each change made to the document. This embodiment saves the change information automatically. Thus, as the document is edited, a permanent record is created of all previous document states. Thus, every previous document state is retrievable through a series of undos beginning with the current document state. Likewise, every successive document state is retrievable through a series of redos beginning with a previous document state.

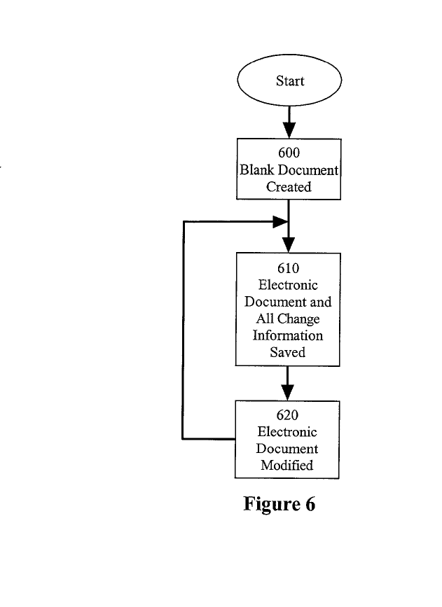

FIG. 6 illustrates document creation and modification in accordance with one embodiment of the present invention. At step 600, a blank document is created. At step 610, the electronic document and all change information are saved. At step 620, the electronic document is modified and the process repeats at step 610.

Retrieval by Series of Undos

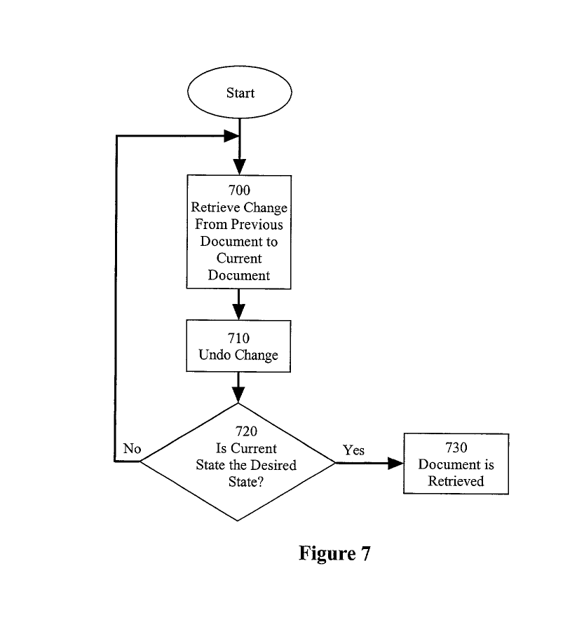

FIG. 7 illustrates the process of document state retrieval using a series of undos beginning at the current document state in accordance with one embodiment of the present invention. At step 700, the change information stored for the transition between the present document state and the immediately previous document state is retrieved. At step 710, the change is undone. At step 720, it is determined whether the new present document state is the desired document state. If the new present document state is the desired document state, at step 730, the desired document state is retrieved. If the new present document state is not the desired document state, the process repeats at step 700.

In one method of the present invention, the process of FIG. 7 is hidden from a user. Thus, the user only sees the retrieved desired document state. The transitional document states are not presented to the user.

Retrieval by Series of Redos

A successive document state is retrievable from an immediately previous document state by redoing the change which transitions the document state to the successive document state. One embodiment retrieves a previous document state redoing the stored changes to the electronic document beginning with a blank document.

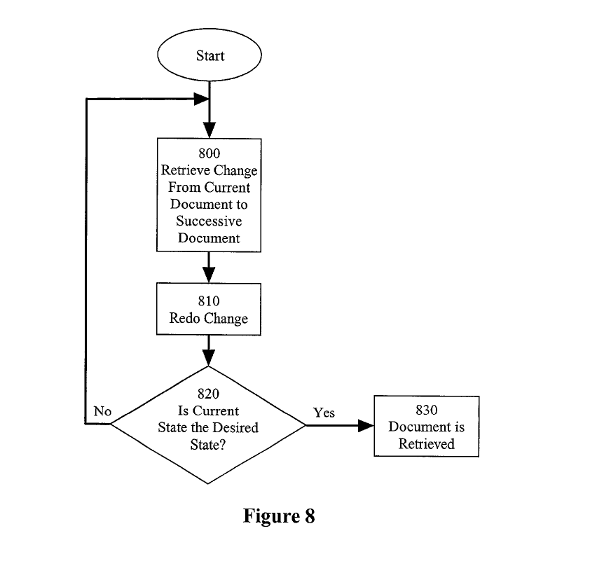

FIG. 8 illustrates the process of document state retrieval using a series of redos beginning with a blank document in accordance with one embodiment of the present invention. At step 800, the change information stored for the transition between the present document state and the immediately successive document state is retrieved. At step 810, the change is redone. At step 820, it is determined whether the new present document state is the desired document state. If the new present document state is the desired document state, at step 830, the desired document state is retrieved. If the new present document state is not the desired document state, the process repeats at step 800.

In one method of the present invention, the process of FIG. 8 is hidden from a user. Thus, the user only sees the retrieved desired document state. The transitional document states are not presented to the user.

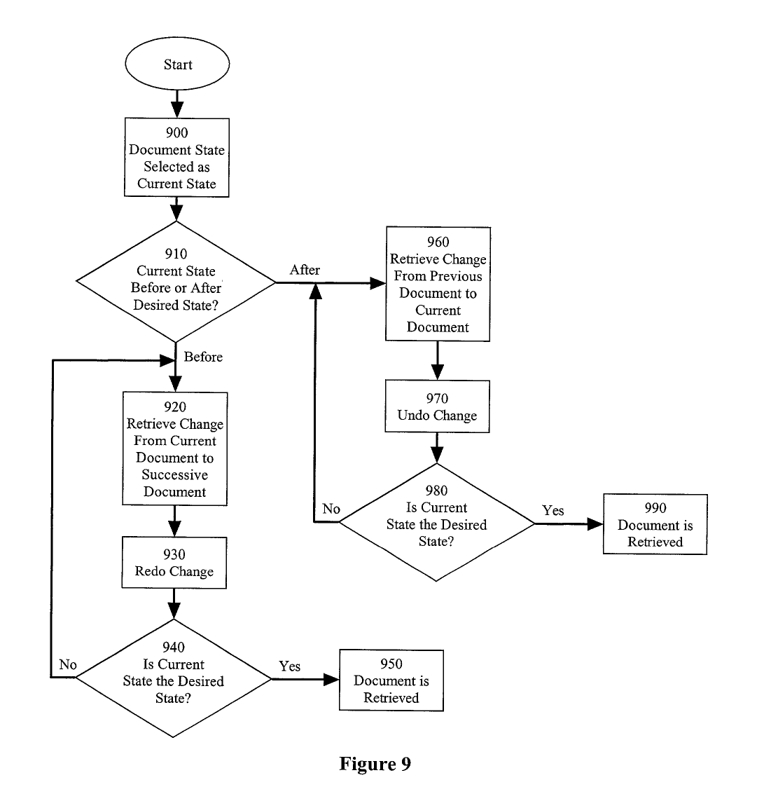

FIG. 9 illustrates the process of document state retrieval using either a series of undos or redos beginning at an arbitrary document state in accordance with one embodiment of the present invention. At step 900, a document state is made the current document state. At step 910, it is determined whether the current document state is before or after the desired document state on a stored change timeline.

If the current document state is before the desired state on a stored change timeline, at step 920, the change information stored for the transition between the present document state and the immediately successive document state is retrieved. At step 930, the change is redone. At step 940, it is determined whether the new present document state is the desired document state. If the new present document state is the desired document state, at step 950, the desired document state is retrieved. If the new present document state is not the desired document state, the process repeats at step 920.

If the current document state is after the desired state on a stored change timeline, at step 960, the change information stored for the transition between the present document state and the immediately previous document state is retrieved. At step 970, the change is undone. At step 980, it is determined whether the new present document state is the desired document state. If the new present document state is the desired document state, at step 990, the desired document state is retrieved. If the new present document state is not the desired document state, the process repeats at step 960.

Interface

One embodiment of the present invention provides an interface for retrieving previous document states. A set of potentially memorable events are arranged in a timeline and used to identify certain previous document states. In one embodiment, the timeline is displayed using a fisheye. In this embodiment, the timeline shows more detail in a region of focus. Thus, events outside the region of focus must meet a higher standard of memorability, or threshold, to be displayed than events inside the region of focus. For example, a document being closed may be displayed in the timeline when that action falls inside the region of focus while the same action is not displayed outside the region of focus.

The region of focus, or fisheye, changes at the request of a user. In one embodiment, the region of focus is originally centered on the current document state. In one embodiment, the standard of memorability required for display increases according to a function as the distance from the center of the region of focus increases.

In one embodiment, closing a document is a memorable event used to identify a document state. In another embodiment, printing a document is a memorable event used to identify a document state. In yet another embodiment, copying or synchronizing the document to another device is a memorable event used to identify a document state. In still another embodiment, attaching the document to an electronic mail message is a memorable event used to identify a document state.

In one embodiment, a user explicitly requesting a document state be saved as memorable is a memorable event used to identify a document state. In another embodiment, the end of a time period (e.g., a day, a week, a month or a year) is a memorable event used to identify a document state. In yet another embodiment, the document remaining unchanged for a significant period of time is a memorable event used to identify a document state.

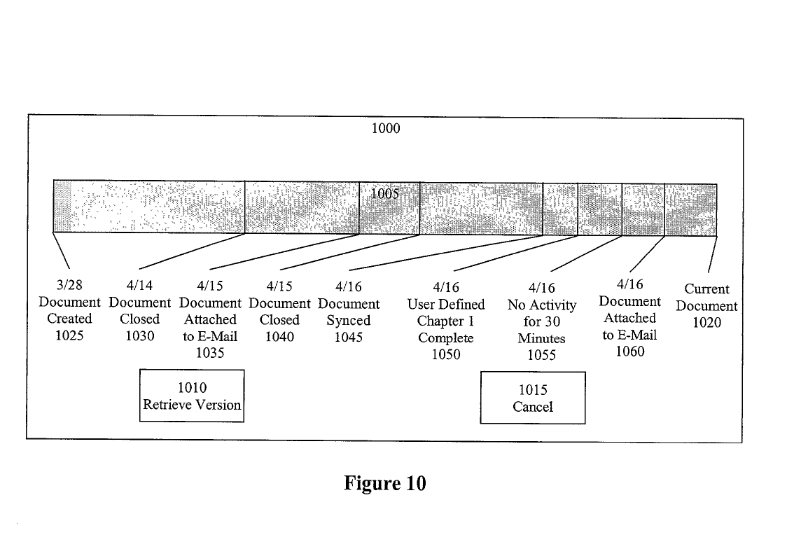

FIG. 10 illustrates a user interface in accordance with one embodiment of the present invention. The interface (1000) comprises a timeline (1005), a retrieve version button (1010) and a cancel button (1015). The timeline comprises potentially memorable events which occurred during the creation of the document.

Since displaying all potentially memorable events may be difficult, confusing or impossible, the timeline uses a focus of attention. Memorable events near the focus of attention must meet a lower standard of memorability to be displayed than memorable events further from the focus of attention. A user may change the focus of attention by clicking on the desired new focus of attention in the timeline.

In FIG. 10, the focus of attention is the current document version (1020). Potentially memorable events displayed on the timeline include “3/28 Document Created” (1025), “4/14 Document Closed” (1030), “4/15 Document Attached to E-Mail” (1035), “4/15 Document Closed” (1040), “4/16 Document Synced” (1045), “4/16 User Defined Chapter 1 Complete” (1050), “4/16 No Activity for 30 Minutes” (1055) and “4/16 Document Attached to E-Mail” (1060).

Previous Document State Selection with Memorable Events

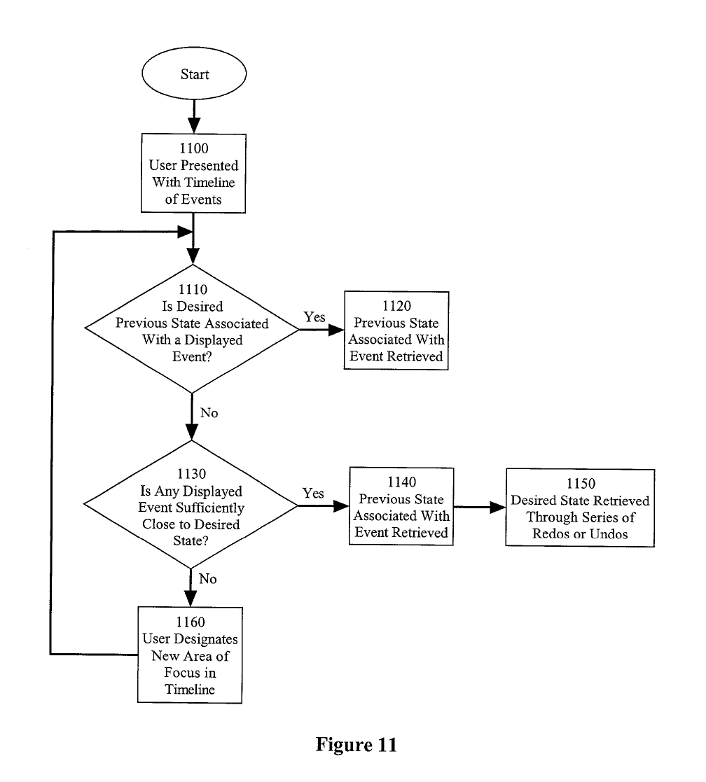

FIG. 11 illustrates the process of selecting a previous document state for retrieval in accordance with one embodiment of the present invention. At step 1100, the user is presented with a timeline of potentially memorable events which occurred during the electronic document modification. At step 1110, it is determined whether the desired previous document state has an associated memorable event displayed in the timeline. If the desired previous document state has an associated memorable event displayed in the timeline, at step 1120, the previous document state associated with the memorable event is retrieved.

If the desired previous document state does not have an associated memorable event displayed in the timeline, at step 1130, it is determined whether there is a displayed memorable event sufficiently close to the desired previous document state. If there is a displayed memorable event sufficiently close to the desired previous document state, at step 1140 the document state associated with the memorable event is retrieved. At step 1150 the desired document state is retrieved through a series of undos or redos originating at the document state associated with the memorable event.

If at step 1130 there is not a displayed memorable event sufficiently close to the desired previous document state, at step 1160, the user designates an area of the timeline as a new region of focus and the process repeats at step 1110. Since memorable events close to the focus of events must meet a lower standard of memorability to be displayed than memorable events further from the focus of events, which memorable events are displayed in the timeline changes as the focus of attention changes.

Electronic Document Creation and Modification with Memorable Events

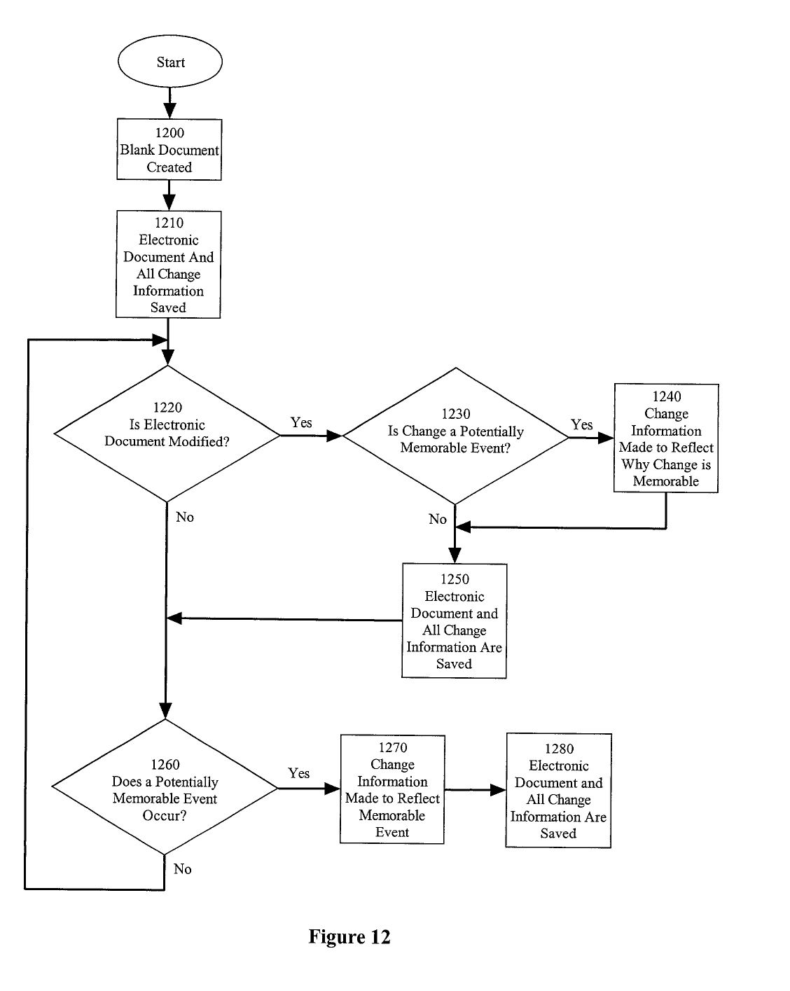

FIG. 12 illustrates document creation and modification in accordance with one embodiment of the present invention. At step 1200, a blank document is created. At step 1210, the electronic document and all change information are saved. At step 1220, it is determined whether the electronic document is modified. If the electronic document is not modified, the process continues at step 1260. If the electronic document is modified, at step 1230, it is determined whether the modification is a potentially memorable event. If the modification is a potentially memorable event, at step 1240, the change information is made to indicate why this change is potentially memorable and the process continues at step 1250.

If at step 1230 the modification is not a potentially memorable event, at step 1250, the electronic document and change information are saved. At step 1260, it is determined if a memorable event occurs. If a potentially memorable event occurs, at step 1270 change information is made to indicate the potentially memorable event. At step 1280, the electronic document and the change information are saved and the process repeats at step 1220. If a potentially memorable event does not occur, the process repeats at step 1220.

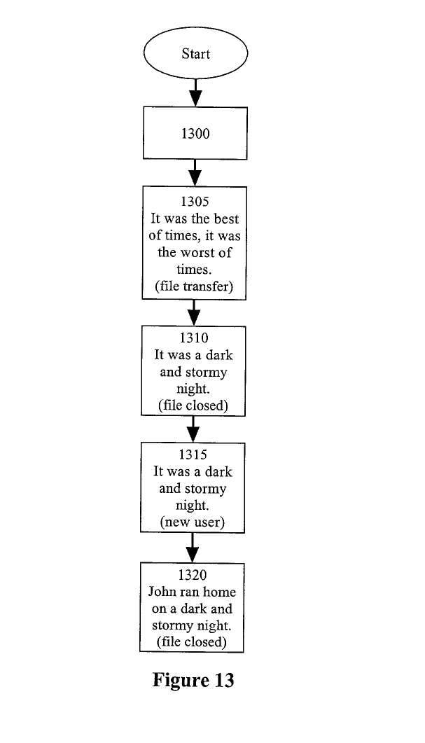

FIG. 13 illustrates the creation of a document in accordance with one embodiment of the present invention. The document starts as a blank document (1300). User 1 modifies the document, and the next document state (1305) is saved when user 1 transfers the file to user 2. User 1 modifies the document, and the next document state (1310) is saved when the document is closed. User 3 opens the document, and the next document state (1315) is saved, indicating that a new user is now editing the document. User 3 modifies the document, and the next document state (1320) is saved when the document is closed.

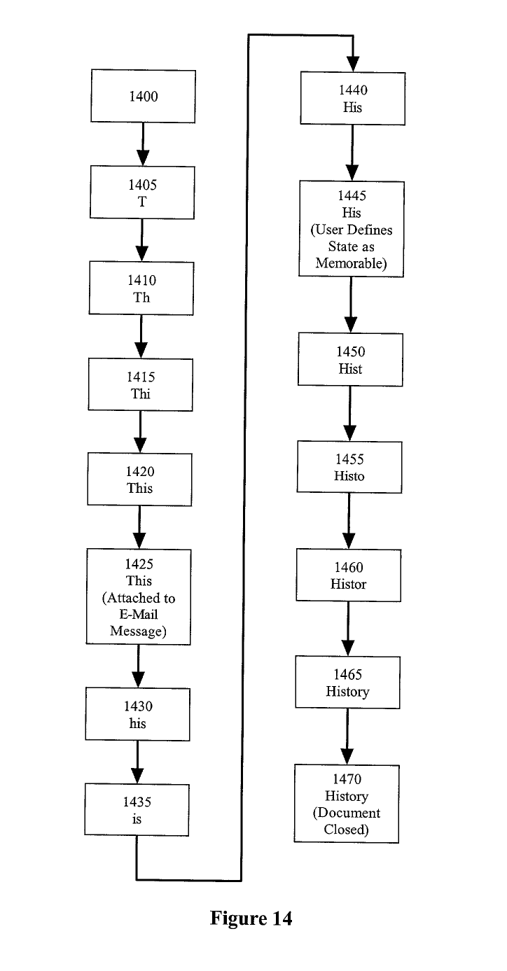

FIG. 14 illustrates the creation of a document in accordance with one embodiment of the present invention. The document starts as a blank document (1400). The next document state (1405) is formed by adding the character “T” to the document. The next document state (1410) is formed by adding the character “h” to the document. The next document state (1415) is formed by adding the character “i” to the document. The next document state (1420) is formed by adding the character “s” to the document.

The document is attached to an e-mail message. In this embodiment, attaching a document to an e-mail message is a potentially memorable event. Thus, the next document state (1425) is formed by indicating the document at the current state was attached to an e-mail message. The next document state (1430) is formed by removing the character “T” from the document. The next document state (1435) is formed by removing the character “h” from the document. The next document state (1440) is formed by adding the character “H” to the document before the character “i.”

The users requests the current document state be defined as a potentially memorable state. Thus, the next document state (1445) is formed by indicating the document at the current state is defined as potentially memorable by the user. The next document state (1450) is formed by adding the character “t” to the document after the character “s.” The next document state (1455) is formed by adding the character “o” to the document. The next document state (1460) is formed by adding the character “r” to the document. The next document state (1465) is formed by adding the character “y” to the document.

The user issues the command to close the document. In this embodiment, closing a document is a potentially memorable event. Thus, the next document state (1470) is formed by indicating the document at the current state was closed.

Embodiment of Computer Execution Environment (Hardware)

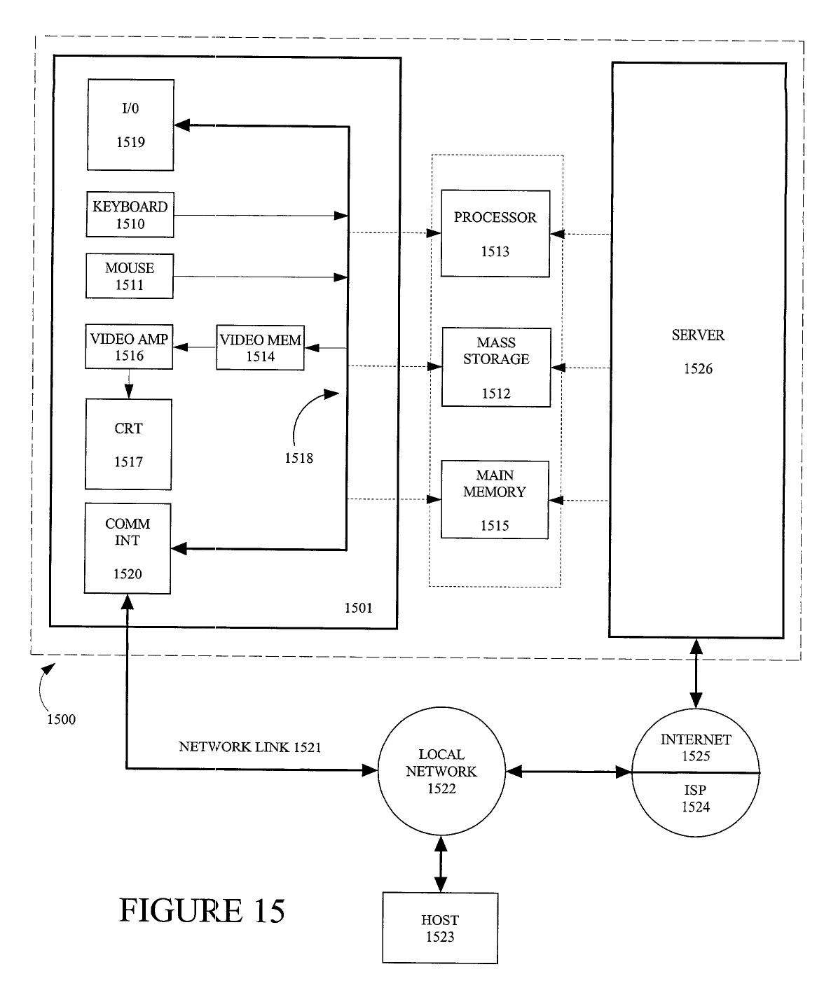

One or more embodiments of the present invention makes recording and/or viewing devices using a general purpose computing device as shown in FIG. 15. A keyboard 1510 and mouse 1511 are coupled to a system bus 1518. The keyboard and mouse are for introducing user input to the computer system and communicating that user input to central processing unit (CPU) 1513. Other suitable input devices may be used in addition to, or in place of, the mouse 1511 and keyboard 1510. I/O (input/output) unit 1519 coupled to bidirectional system bus 1518 represents such I/O elements as a printer, A/V (audio/video) I/O, etc.

Computer 1501 may include a communication interface 1520 coupled to bus 1518. Communication interface 1520 provides a two-way data communication coupling via a network link 1521 to a local network 1522. For example, if communication interface 1520 is an integrated services digital network (ISDN) card or a modem, communication interface 1520 provides a data communication connection to the corresponding type of telephone line, which comprises part of network link 1521. If communication interface 1520 is a local area network (LAN) card, communication interface 1520 provides a data communication connection via network link 1521 to a compatible LAN. Wireless links are also possible. In any such implementation, communication interface 1520 sends and receives electrical, electromagnetic or optical signals which carry digital data streams representing various types of information.

Network link 1521 typically provides data communication through one or more networks to other data devices. For example, network link 1521 may provide a connection through local network 1522 to local server computer 1523 or to data equipment operated by ISP 1524. ISP 1524 in turn provides data communication services through the world wide packet data communication network now commonly referred to as the “Internet” 1525. Local network 1522 and Internet 1525 both use electrical, electromagnetic or optical signals which carry digital data streams. The signals through the various networks and the signals on network link 1521 and through communication interface 1520, which carry the digital data to and from computer 1500, are exemplary forms of carrier waves transporting the information.

Processor 1513 may reside wholly on client computer 1501 or wholly on server 1526 or processor 1513 may have its computational power distributed between computer 1501 and server 1526. Server 1526 symbolically is represented in FIG. 15 as one unit, but server 1526 can also be distributed between multiple “tiers”. In one embodiment, server 1526 comprises a middle and back tier where application logic executes in the middle tier and persistent data is obtained in the back tier. In the case where processor 1513 resides wholly on server 1526, the results of the computations performed by processor 1513 are transmitted to computer 1501 via Internet 1525, Internet Service Provider (ISP) 1524, local network 1522 and communication interface 1520. In this way, computer 1501 is able to display the results of the computation to a user in the form of output.

Computer 1501 includes a video memory 1514, main memory 1515 and mass storage 1512, all coupled to bidirectional system bus 1518 along with keyboard 1510, mouse 1511 and processor 1513. As with processor 1513, in various computing environments, main memory 1515 and mass storage 1512, can reside wholly on server 1526 or computer 1501, or they may be distributed between the two. Examples of systems where processor 1513, main memory 1515, and mass storage 1512 are distributed between computer 1501 and server 1526 include the thin-client computing architecture developed by Sun Microsystems, Inc., the palm pilot computing device and other personal digital assistants, Internet ready cellular phones and other Internet computing devices, and in platform independent computing environments, such as those which utilize the Java technologies also developed by Sun Microsystems, Inc.

The mass storage 1512 may include both fixed and removable media, such as magnetic, optical or magnetic optical storage systems or any other available mass storage technology. Bus 1518 may contain, for example, thirty-two address lines for addressing video memory 1514 or main memory 1515. The system bus 1518 also includes, for example, a 32-bit data bus for transferring data between and among the components, such as processor 1513, main memory 1515, video memory 1514 and mass storage 1512. Alternatively, multiplex data/address lines may be used instead of separate data and address lines.

In one embodiment of the invention, the processor 1513 is a SPARC microprocessor from Sun Microsystems, Inc., a microprocessor manufactured by Motorola, such as the 680X0 processor, or a microprocessor manufactured by Intel, such as the 80X86 or Pentium processor. However, any other suitable microprocessor or microcomputer may be utilized. Main memory 1515 is comprised of dynamic random access memory (DRAM). Video memory 1514 is a dual-ported video random access memory. One port of the video memory 1514 is coupled to video amplifier 1516. The video amplifier 1516 is used to drive the cathode ray tube (CRT) raster monitor 1517. Video amplifier 1516 is well known in the art and may be implemented by any suitable apparatus. This circuitry converts pixel data stored in video memory 1514 to a raster signal suitable for use by monitor 1517. Monitor 1517 is a type of monitor suitable for displaying graphic images.

Computer 1501 can send messages and receive data, including program code, through the network(s), network link 1521, and communication interface 1520. In the Internet example, remote server computer 1526 might transmit a requested code for an application program through Internet 1525, ISP 1524, local network 1522 and communication interface 1520. The received code may be executed by processor 1513 as it is received, and/or stored in mass storage 1512, or other non-volatile storage for later execution. In this manner, computer 1500 may obtain application code in the form of a carrier wave. Alternatively, remote server computer 1526 may execute applications using processor 1513, and utilize mass storage 1512, and/or video memory 1515. The results of the execution at server 1526 are then transmitted through Internet 1525, ISP 1524, local network 1522 and communication interface 1520. In this example, computer 1501 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a method and apparatus for automatic electronic document versioning system is described in conjunction with one or more specific embodiments. The invention is defined by the following claims and their full scope an equivalents.

1. A method for obtaining a desired state of a document comprising:
identifying a plurality of events;
storing a plurality of states associated with said document upon the occurrence of said plurality of events; and
obtaining said desired state using said plurality of states.

2. The method of claim 1 wherein said step of obtaining further comprises:
transitioning from a previous state to a current state in said plurality of states.

3. The method of claim 1 wherein said step of obtaining further comprises:
transitioning from a current state to a previous state in said plurality of states.

4. The method of claim 1 wherein said events comprise closing said document.

5. The method of claim 1 wherein said events comprise copying said document.

6. The method of claim 1 wherein said events comprise synchronizing said document with a device.

7. The method of claim 1 wherein said events comprise a different user begins editing said document.

8. The method of claim 1 wherein said events comprise transmitting said document using a file transfer mechanism.

9. The method of claim 8 wherein said file transfer mechanism is an e-mail message.

10. The method of claim 8 wherein said file transfer mechanism is a chat program.

11. The method of claim 1 wherein said events comprise a user defined event.

12. The method of claim 1 wherein said events comprise a failure to modify said document within a given time period.

13. The method of claim 1 wherein said events comprise a modification of said document.

14. The method of claim 1 wherein said events comprise printing said document.

15. A document versioning system comprising:
an event identifier configured to identify a plurality of events;
a state device configured to store a plurality of states associated with a document upon the occurrence of said plurality of events; and
a version obtainer configured to obtain said desired state using said plurality of states.

16. The document versioning system of claim 15 wherein said version obtainer is further configured to transition from a previous state to a current state in said plurality of states.

17. The document versioning system of claim 15 wherein said version obtainer is further configured to transition from a current state to a previous state in said plurality of states.

18. The document versioning system of claim 15 wherein said events comprise closing said document.

19. The document versioning system of claim 15 wherein said events comprise copying said document.

20. The document versioning system of claim 15 wherein said events comprise synchronizing said document with a device.

21. The document versioning system of claim 15 wherein said events comprise a different user begins editing said document.

22. The document versioning system of claim 15 wherein said events comprise transmitting said document using a file transfer mechanism.

23. The document versioning system of claim 22 wherein said file transfer mechanism is an e-mail message.

24. The document versioning system of claim 22 wherein said file transfer mechanism is a chat program.

25. The document versioning system of claim 15 wherein said events comprise a user defined event.

26. The document versioning system of claim 15 wherein said events comprise a failure to modify said document within a given time period.

27. The document versioning system of claim 15 wherein said events comprise a modification of said document.

28. The document versioning system of claim 15 wherein said events comprise printing said document.

29. A computer program product comprising:
a computer usable medium having computer readable program code embodied therein configured to obtain a desired state of a document, said computer program product comprising:
computer readable code configured to cause a computer to identify a plurality of events;
computer readable code configured to cause a computer to store a plurality of states associated with said document upon the occurrence of said plurality of events; and
computer readable code configured to cause a computer to obtain said desired state using said plurality of states.

30. The computer program product of claim 29 wherein said computer readable code configured to cause a computer to obtain further comprises:
computer readable code configured to cause a computer to transition from a previous state to a current state in said plurality of states.

31. The computer program product of claim 29 wherein said computer readable code configured to cause a computer to obtain further comprises:
computer readable code configured to cause a computer to transition from a current state to a previous state in said plurality of states.

32. The computer program product of claim 29 wherein said events comprise closing said document.

33. The computer program product of claim 29 wherein said events comprise copying said document.

34. The computer program product of claim 29 wherein said events comprise synchronizing said document with a device.

35. The computer program product of claim 29 wherein said events comprise a different user begins editing said document.

36. The computer program product of claim 29 wherein said events comprise transmitting said document using a file transfer mechanism.

37. The computer program product of claim 36 wherein said file transfer mechanism is an e-mail message.

38. The computer program product of claim 36 wherein said file transfer mechanism is a chat program.

39. The computer program product of claim 29 wherein said events comprise a user defined event.

40. The computer program product of claim 29 wherein said events comprise a failure to modify said document within a given time period.

41. The computer program product of claim 29 wherein said events comprise a modification of said document.

42. The computer program product of claim 29 wherein said events comprise printing said document.
